(19) United States
(12) Patent Application Publication
(10) Pub. No.: US 2007/0043647 A1
(43) Pub. Date: Feb. 22, 2007

(54) Electronic trading environment with price improvement

(75) Inventor: Michael Bickford, Basking Ridge, NJ (US)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: American Stock Exchange LLC, New York, NY (US)

(21) Appl. No.: 11/204,395

(22) Filed: Aug. 16, 2005

(51) Int. Cl. G06Q 40/00

(52) U.S. Cl. 705/37; 705/36 R

(57) ABSTRACT

The invention includes systems and methods for price improvement in an electronic trading environment. The systems of the invention may include such components as auction clients for market participants to provide best prices and an auction module to coordinate auctions. The methods of the invention may include receiving best price quotes from market participants, the determination of best prices, and order execution based on single matches, multiple matches, and multiple matches on both sides of an order.

### FIELD OF THE INVENTION

The invention generally relates to systems and methods for electronic trading.

### BACKGROUND

Historically, security and commodity exchanges have been run as open-outcry type auctions, with individuals dealing face-to-face to conduct transactions. In recent years, exchanges have been moving towards conducting transactions electronically, and several exchanges conduct all transactions electronically. In these electronic exchanges, orders are received electronically and automatically matched with other orders in a small fraction of the time that it takes to execute transactions in the open-outcry markets. Some exchanges, including the American Stock Exchange (“Amex”), have adopted hybrid trading environments involving both open-outcry and electronic trading.

In open-outcry markets, an investor-customer order is relayed to a broker, who announces the order to market professionals - floor brokers, specialists, and market makers. The market professionals reply verbally with bid and offer prices for the order. For market orders, a trade results when the broker selects the best price from among the market professionals for the order. For limit orders, a trade results only when the best price from among the market professionals is as good or better than the price specified by the customer in the limit order. The advantage of open-outcry trading over electronic trading is that the auction-style trades often result in better prices for investors, and market participants can get a better feel for the market.

Many types of electronic markets exist, but the basic structures of most electronic markets center on electronic order books. A typical transaction on an electronic market begins when an investor-customer order is received electronically. The order is compared with orders residing on an electronic order book. If an order on the electronic order book is a matching counterpart to the incoming order, the incoming order is matched to the matching counterpart in the electronic order book, and a trade results. If there are no matching counterparts in the order book, then market professionals (specialists and market makers) are given the opportunity to fill the order at current market prices for market orders or, if the market prices are as good or better than the customer-specified prices, for limit orders. Any portion of the incoming order that is not filled by matching with existing orders in an order book or by market professionals is stored in the electronic order book. Because all market orders should be filled by market professionals at quoted market prices, only limit orders are generally stored in the order book. The advantage of electronic trading over open-outcry trading is the speed with which trade orders are executed, typically in fractions of a second.

One of the disadvantages of existing electronic trading systems is that they do not provide incentives for market professionals to easily improve quoted market prices. An exchange tracks the bid and offer prices for each security quoted by the market professionals and quotes the best bid and offer prices at any given time. However, market professionals are required to fill orders automatically on a predetermined rotating basis, so individual market professionals have no incentive to lower offer prices or raise bid prices because they will not benefit from increased order volume over the other market professionals.

The Amex's hybrid market combines the benefits of open-outcry and electronic markets. Like other electronic markets, it provides automated order execution, and electronic post-trade allocation. However, unlike purely electronic markets, the Amex's hybrid market also supports auctions and negotiated trades in a traditional open-outcry format. Investors have the option of selecting automatic order execution, or routing their orders to the floor for negotiated trading and possible price improvement.

For many years, the Amex and other national exchanges have had “trade-through” rules that limit trading at prices worse than those offered at other exchanges. During an open-outcry auction, the best quotations from the market makers would be broadcast over a network called the Consolidated Quote System (“CQS”). (In options markets, a similar system called the Intermarket Linkage System is used.) Using the quotations listed on the CQS, an exchange would compare bids and offers on a security with those at other exchanges for the same security, and prevent transactions from occurring at prices that were less favorable to the customer than were available at another exchange. The Securities and Exchange Commission (“SEC”) has recently adopted Regulation NMS (National Market System), which contains an “order protection rule,” which is similar conceptually to the trade-through rule, requiring trading centers to have policies and procedures in place that are reasonably designed to prevent the execution of orders at prices lower than the best bid or greater than the best offer when those prices are represented by automated quotations that are immediately accessible.

With the adoption of Regulation NMS and its requirement that orders be executed only at the best prices across trading centers, it is anticipated that markets will benefit from new systems and methods for price improvement. This is especially true of newer electronic markets that have the benefit of rapid transactions, but lack the same facilities for price improvement of traditional auction-based markets. Systems and methods that can combine the benefits of these two types of markets will find an enthusiastic response from investors and other market participants.

### SUMMARY OF THE INVENTION

Accordingly, it is an object of the invention to provide trading systems and methods that incorporate the most desirable features of electronic and open-outcry trading environments. One embodiment of the invention thus includes an electronic auction process that combines the benefits of rapid electronic order fulfillment with the price improvement possibilities provided by open-outcry trading. The inventions include methods for improving the price of a financial instrument, systems for implementing these methods, and computer program products to run on computer systems for implementing these methods.

One embodiment of a method of the invention includes performing the following steps on a first computer system running an auction module computer program product and on a second computer system means running an auction client computer program product. The auction module receives an auction request from an auction initiator, and the auction request comprises data specifying the identity of the financial product. The auction module transmits the auction request to a plurality of auction clients in the form of data specifying the identity of the financial product. The auction module receives data comprising prices from the auction clients and orders and quotes from an electronic order and quote book. The auction module compares the prices from the auction clients and quotes from the electronic orders and quotes book. The auction module determines whether the auction should be terminated and selects the best price.

On a second computer means, the auction client receives the data specifying the identity of the financial product. The auction client receives data input from an auction participant comprising the auction participant's best prices for the financial product. The auction client transmits data comprising improved prices to the auction module. On the close of the auction, the auction initiator has the option of executing a transaction for the order at the best price.

The auction request may further comprise data specifying a quantity of the financial instrument and a side of the order. The side of the order may be a buy order, a sell order, or a sell short order, for example. The method may further comprise the step of determining with the first computer means that there is an ongoing auction and joining the auction request with the ongoing auction. The method may further comprise the step of determining with the first computer means that there are multiple matches on both sides and notifying a specialist that there are multiple matches on both sides, wherein the specialist intervenes, sets a price, and executes the transactions.

### BRIEF DESCRIPTIONS OF THE DRAWINGS

FIG. 1 is a flow diagram illustrating one example of data flow within the structure of a market that may employ the electronic price improvement systems and methods of the invention.

FIG. 2 is a flow diagram illustrating one example of data flow into the order and quote book.

FIG. 3 is a block diagram illustrating one example of a system of the invention to allow price improvement in an electronic or hybrid trading environment.

FIG. 4 is a flow diagram illustrating one embodiment of the auction process portion of the invention.

FIG. 5 is a flow diagram illustrating one embodiment of the orders auction process of the invention.

### DETAILED DESCRIPTION

The invention includes various systems and methods for use in an electronic trading environment for trading commodities and financial instruments including equity and debt securities, exchange traded funds, and options contracts. A preferred embodiment of the invention includes a computer program product for conducting auctions in the computerized portion of a hybrid electronic and open-outcry trading environment, such as that of the Amex. In other embodiments, the computer program product for conducting auctions can be used in a purely electronic trading environment.

The Amex hybrid market structure provides customer-investors with several options for trading. They have the choice of simple automated execution, automated execution with electronic price improvement using the auction window of the invention, through point-of-sale floor representation, or through traditional open-outcry auctions. The latter three options provide opportunities for price improvement over the published best bids and offers and eligibility to participate in the Amex's specialist auction process. Furthermore, the Amex hybrid market structure may be used to provide market stability by limiting access to automated execution when there is a need to minimize volatility in times of market stress or for thinly traded stocks. Under certain pre-publicized conditions, the specialist auction process may be used to reduce volatility and thus improve the market in times of stress.

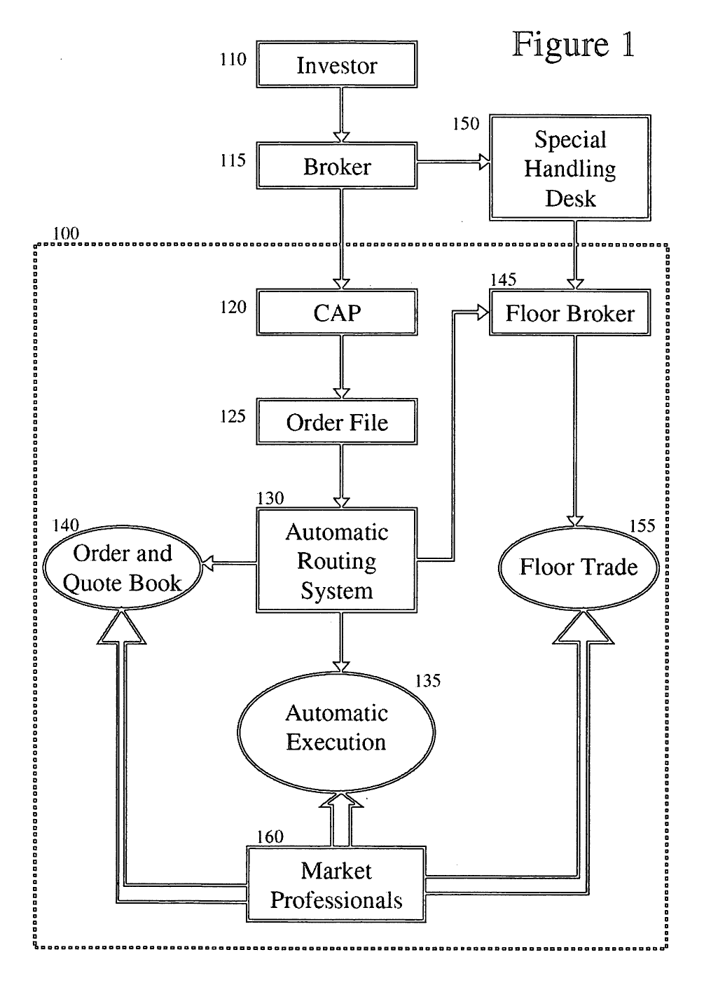

FIG. 1 is a block diagram illustrating one example of the structure of a market that may employ the electronic price improvement systems and methods of the invention. It should be noted, however, that FIG. 1 is for illustrative purposes only, and that the electronic price improvement systems and methods of the invention may be used in markets with any of a variety of structures. The structure underlying FIG. 1 is comprised of a computer network allowing data transfer between computers located at brokerage firms and within an exchange, as well as a physical structure that provides areas for specialists, market makers, and floor brokers (collectively the “crowd”) to interact. As is well recognized by the financial industry, most or all of the market participants use computers for recording transactions, receiving and quoting pricing information, and communication. Computer means are used within the exchange for order receipt, order processing and routing, and order recording, as well as for maintenance of the order and quote book, as detailed below.

A trade begins with an investor 110 placing an order with a brokerage firm through a broker 115. The broker 115 sends the order to the exchange 100 through the exchange's central access point (CAP) 120, such as the Amex's common message switch (CMS).

Data is extracted from the order and an electronic order file 125 is created that specifies the details of the order. The order file may specify some or all of the following attributes, or additional attributes not listed: whether the trader making the order is a customer or a market professional, the security or securities that are the subject of the order, the quantity of securities that are the subject of the order, the order type (e.g., market order, limit order, auction limit order, stop order, stop limit order, etc.), the side of the transaction requested in the order (e.g., buy, sell, sell short, etc.), time limits on execution, execution qualifiers (e.g., all-or-nothing—total order fulfillment or none, minimum fill—a minimum amount of the order is filled before its total size is revealed, etc.), and a settlement qualifier (e.g., regular, cash, next day, seller's option).

The order file 125 is sent to an automated routing system (ARS) 130, such as the Amex's Booth Automated Routing System (BARS). The ARS 130 analyzes the information in the order file and decides where to send the order for execution. If the order is a limit order that cannot be filled at current market prices, the order may be routed to the order and quote book 140. The order and quote book 140 contains the orders and quotes submitted by specialists, market makers, and floor brokers.

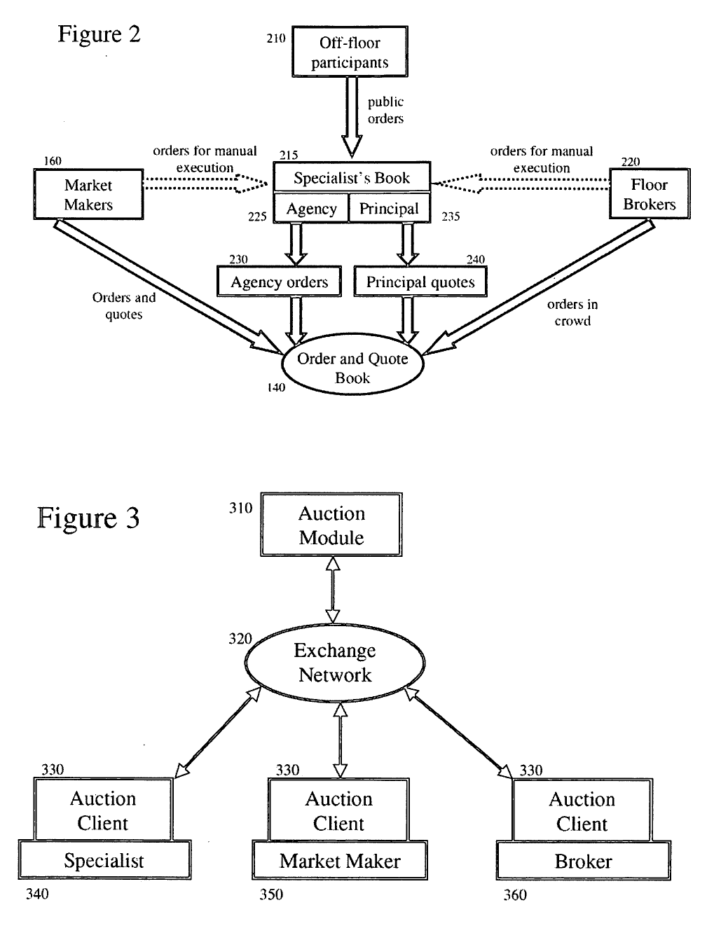

FIG. 2 illustrates how data is input into the electronic order and quote book. Quotes and orders are submitted by market makers 160 and floor brokers 220 standing in the crowd of market professionals. Market makers 160 and floor brokers 220 may interact with the book 140 directly, with market makers 160 entering quotes and floor brokers 220 entering in-crowd orders. Occasionally, certain orders that should not be handled automatically may be routed through the specialist's book 215 to be handled manually by a specialist. For example, orders that may cause a trade-through may be routed to the specialist's book for manual execution at the best price or to be routed to the market that quotes the best price. Other orders that may be routed to the specialist's book 215 include orders that are greater in volume than current quotes allow. A specialist that receives an order in the specialist's book 215 may be given a certain amount of time, for example 30 seconds, to manually handle the order. Agency orders 230, including orders from floor brokers 220 and public orders from off-floor participants 210, are entered in the book 140, and quotes 240 are likewise entered in the book 140.

Returning to FIG. 1, limit orders that are not immediately fillable at market prices may alternatively be routed to a floor broker 145 for possible price improvement that would allow the limit order to be filled. Market orders and limit orders that are fillable at market prices may be routed by the ARS 130 for automatic execution 135. The automatic execution step 135 preferably occurs within the order and quote book 140.

Orders designated for traditional open-outcry floor trading are routed by the ARS 130 to a floor broker 145, where a verbal auction is conducted among the specialists and (if the order involves an ETF or an option, for example) market makers 160 for the security on the trading floor 155. (Alternatively, orders sent to the trading floor 155 may be sent to a special handling desk 150 within the brokerage firm and from there sent to a floor broker 145.) Whether an order is routed to the book 140, for automatic execution 135, or for floor trading 155, the market professionals 160 are part of each transaction. They continuously provide quotes to the book 140 and monitor it to determine whether orders on the book may be filled at current market conditions. They serve as the counterparty to orders that are automatically executed 135 at current market conditions. And they actively participate in open-outcry auctions on orders routed for floor trading 155.

The systems and methods of the invention can work within the hybrid trading system described above with reference to FIG. 1, or they can work within any purely electronic trading system with modifications that would be readily apparent to those skilled in the financial industry. For example, FIG. 1 can be simply modified by removing floor trading 155 and routing to floor brokers 145 in order to create a purely electronic market.

FIG. 3 is a block diagram illustrating one example of a system of the invention to allow price improvement in an electronic or hybrid trading environment. It should be noted that FIG. 3 is only a single example of a structure of the invention for allowing price improvements, and that modifications to the structure shown in FIG. 3 or other structures may also be used in accordance with the invention. FIG. 3 shows specialists 340, market makers 350, and brokers 360 interacting through a network 320 with each other through an auction module 310. Each specialist 340, market maker 350, and broker 360 operates a computer running auction client 330 software that allows each computer to interface through a computer network 320 with another computer running auction module 310 software. The relationship between auction clients 330 and auction modules 310 may be any networking relationship, for example, client-server or peer-to-peer, and may employ any networking protocols. The exchange network 320 can be any communications network, for example, it may be a local area network including only a few computers within the exchange, or a wide area network, or even the internet. Standard security protocols may be used on any of the networks, especially the more public networks.

The auction client 330 may be a component of a larger computer program product used by the market participants to track their inventories, orders, quotations, and trades. For example, it may comprise a window in a graphical user interface that can be initiated by a market participant to conduct an auction. Alternatively, the auction client 330 may be a stand-alone software program. Any authorized market participant trading in a particular financial instrument and using an auction client 330 may initiate an electronic auction to possibly improve the price of the financial instrument, to determine market interest in the instrument, or for market price discovery. Other market participants trading in the financial instrument and also using an auction client 330 may be notified of the instantiation of the auction. The initiator and the other participants may electronically enter the auction to indicate their best offers to buy or sell the financial instrument. The initiator may be provided the option to terminate the auction, or the auction module 310 may automatically terminate the auction upon some predetermined event, such as the passage of a sufficient amount of time indicating a lack of interest in further price improvements. Upon termination of the auction, the initiator may select the best price from among the participants and decide whether to conduct a transaction at that price or not.

The auction module software 310 is preferably run on a computer system separate from the computer systems running the auction client software 330, and most preferably, the auction module software 310 is run on an exchange computer. The auction module 310 may comprise a software component of a more comprehensive automated trading program that may include such components as automated routing and automated trade execution, or the auction module 310 may be a stand-alone program. As described in detail below, the auction module 310 sends notifications to and coordinates the interactions among the various market participants who participate in the auctions.

The auction module 310 may be configured to dynamically create an electronic auction for a financial instrument based on a request received from an auction client 330 or based on some predetermined rule, for example, the auction module 310 may create an electronic auction after some predetermined time has passed since the most recent quote update in order to determine the current best price available for the purchase and/or sale of a financial instrument in order to generate current quotes. The auction module 310 may also be configured to send messages to the auction clients 330 to notify prospective participants of an electronic auction that it initiates. The auction module 310 may further be configured to receive bid and offer prices during an auction, to report the best price at the end of an auction, and to transmit the best price to another system for tracking best prices.

The auction module 310 may further be configured to allocate trades among the auction participants. For example, the auction module 310 may award an entire order to the auction participants whose prices submitted in the auction are best. This order allocation scheme provides incentives to market participants for improving prices that does not exist in order allocation schemes in other electronic markets. In some embodiments, the auction module 310 may be configured to allocate orders among market participants in a predetermined allocation scheme, for example, by giving preference to public customers, then to specialists, and finally to market makers. In other embodiments, the auction module 310 may be configured to give preference to public customers, then allocate any remainder of the order with preference given to the market professionals whose prices submitted in the auction are best. In yet other embodiments, order allocation may be left to another system within the exchange, and the auction module 310 may simply transmit the results of the auction to an allocation system within the exchange.

The system of FIG. 3 and other similar systems allow market participants to conduct an electronic auction for price improvement on an order, to determine market interest in filling an order, or for market price discovery. It should be noted that the auctions involving specific orders as described herein are intended to result in price improvement, meaning that if the order is to buy shares of a security then a better price is a lesser price, whereas if the order is to sell shares of a security then a better price is a greater price. A benefit of using a computerized and networked system for conducting an auction for these purposes rather than a traditional open-outcry auction is that the electronic auction can be conducted in a fraction of the time of a traditional auction. Thus the time required to fill an order can be reduced while retaining the benefits of price improvement gained from an auction.

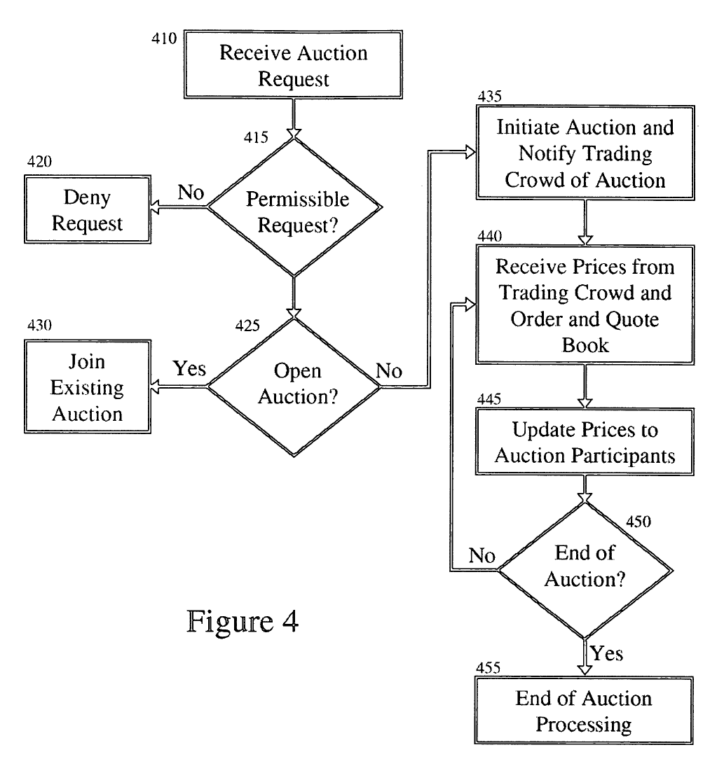

FIG. 4 is a flow diagram illustrating one embodiment of the auction process portion of the invention. The auction process illustrated in FIG. 4 is just one example of auction processes that can be used within the methods of the invention, and it can be modified by adding, removing, or altering the steps without departing from the spirit of the invention. In the embodiment shown in FIG. 4, the auction module performs the steps.

In step 410, the auction module receives a request to initiate an auction. As discussed in detail below, requests to initiate auctions can be sent by various market participants, or the auction module may initiate auctions based on predetermined criteria. In step 415, the auction module determines whether the request for auction is a permissible request based on, for example, whether the financial instrument that is the subject of the auction request is a financial instrument that is traded on the exchange and whether the financial instrument is currently trading. If the auction module determines that the auction request is not permissible, then in step 420, the auction module may deny the request, and send notification to the requestor that the request is denied.

In step 425, the auction module determines whether there is already an ongoing auction for the financial instrument that is the subject of the auction request. If there is already an ongoing auction for the financial instrument, then in step 430 the auction module may send a notification to the requestor that there is an existing auction and invite the requester to join the existing auction. If the requestor's order is on the same side (i.e., buy or sell) as the order that is the subject of the existing auction, priority may be given to the order that is the subject of the existing auction when the auction ends and the orders are filled. Alternatively, if the requestor's order is on the opposite side of the order that is the subject of the existing auction, then a two-sided auction may take place, with various market professionals providing both best bid and best offer prices.

If there is no open auction for the financial instrument, then in step 435, the auction module may initiate an auction and send notification of the auction to the trading crowd. The notification may be, for example, an electronic message sent over the exchange network and received by the trading crowd members' auction clients.

In response to the notification 435, the participating members of the trading crowd send their prices, which are received by the auction module in step 440, along with liquidity indicators from the order and quote book and other pertinent pricing information, including pricing data from competing markets. The participants may send their prices, for example, as electronic data from their auction clients over the exchange network. In other embodiments, the participants may send their prices through their auction clients over the exchange network directly to the other participants' auction clients and/or to the auction module. The auction module may be configured to query the order and quote book on current price quotes over the exchange network, or the auction module may be run on the same computer system as or on a local area network with the computer system that stores the order and quote book.

The participants may manually enter their prices into their auction clients during an auction, which may then be sent over the exchange network, or the participants may manually or automatically upload their prices into their auction clients before or during an auction, and the prices may automatically be sent over the exchange network. For example, market professionals may manually or automatically enter or upload their best prices into their auction clients prior to or during an auction, then during an auction, the auction clients may automatically determine whether the best prices entered or uploaded into the auction clients are better than the best prices broadcast by the auction module, listed in the order and quote book, or otherwise listed.

If the auction clients determine that the entered or uploaded prices are better than the broadcast or listed prices, then the auction clients may automatically send improved prices. The improved prices may be some predetermined increment better than the best broadcast or listed price, and may be as good as the best prices entered or uploaded into the auction clients. In a preferred embodiment, the auction clients automatically determine whether the best prices in the auction clients are better than the current best prices as determined during an auction, and if so automatically send an auction price incrementally better by some predetermined increment to the auction module and/or directly to the other auction clients.

A fully automated auction process, in which participants' best prices are pre-programmed in the auction clients and the auction clients automatically send incrementally better prices, if available, is preferable because it results in very fast auctions, and thus in very fast quotations and trades. Furthermore, if allocation preferences are provided to the market professionals who win their auctions, then the market professionals will be more motivated to frequently update and improve their best prices.

In step 445, the best prices are sent to the participants, for example, as data from the auction module sent over the exchange network to the trading crowd members' auction clients. In a preferred embodiment, the best prices are sent to participants immediately upon receipt of the prices at the auction module. In another embodiment, the best prices are periodically sent to participants at predetermined times. Alternatively, each participant's prices may be sent directly to other participants over the exchange network.

In step 450, the auction module determines whether the auction should be terminated. The auction module may be configured to determine that the auction should be terminated based on one or more events. For example, the auction module may determine that the auction should be terminated if the party that requested the initiation of the auction subsequently requests termination of the auction because an acceptable price has been reached and a transaction may be executed, because no acceptable price has been reached and no transaction will be executed, or because adequate price information has been determined from the auction if the auction was initiated for determining price information. Or the auction module may determine that the auction should be terminated if some predetermined amount of time has lapsed since the beginning of the auction or since the last improved price submission from an auction participant. Preferably, the auction module automatically terminates the auction when a bid price matches an offer price. If the auction is not terminated, the process returns to step 440 and awaits further prices from the participants.

In step 455, the auction module performs the end of auction processing. The nature of this processing depends on the type of and reason for the auction, and is discussed in more detail below. For example, if the auction is for price improvement on an order that is then to be executed at the best price as determined by the auction, then allocation of that order may go to the participants whose prices were the best. Thus, in this situation, the end of auction processing may include the transmission of data comprising information on which participants' prices were the best to an order allocation module. End of auction processing may also include, for example, transmitting the best price as determined by the auction to the order and quote book, sending any unfilled portion of the order to the order and quote book, transmitting any information about any trade resulting from the auction to the systems within the exchange responsible for tracking and recording trades, and notifying the auction participants or the trading crowd of the close of the auction and of any resulting trades.

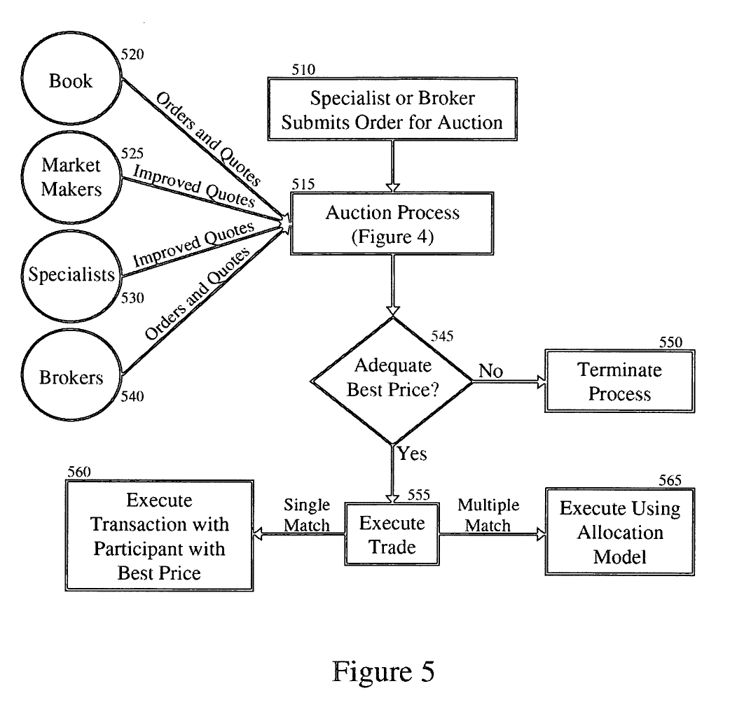

FIG. 5 is a flow diagram illustrating one embodiment of the orders auction process of the invention. The process begins in step 510 with a decision on the part of a specialist or broker to submit an order for an auction, and to thus initiate the auction. The specialist or broker who submits an order for auction may transmit the order through the auction client, over the network to the crowds' auction clients, or preferably to the auction module, which then transmits the order to the crowds' auction clients. The auction is conducted in step 515, for example according to the process shown in FIG. 4 and described in the accompanying text, with input from the Book 520 in the form of orders and quotes on the book, from market makers and specialists as auction participants submitting improved price quotes, and from brokers (and potentially specialists) submitting orders and improved price quotes.

In step 545, the auction module determines whether the best price that results from the auction is adequate to fill the auctioned order. If not, then the process terminates in step 550. Termination of the auction process may be accomplished in a number of different ways. Preferably, the auction is terminated after a predetermined amount of time. For example, in a manual auction in which market professionals manually enter their best prices for an order, an auction may be terminated 5 seconds after it begins. Or, in an automated auction, in which market professionals pre-program their auction clients with their best prices, an auction may be terminated in a fraction of a second after it begins. The invention is not limited to any particular time duration for auctions, although the amount of time for an auction should preferably be disclosed to potential participants before it begins.

If the best price is adequate, then in step 555, a trade is executed. If there is a single best price discovered in the auction from a single auction participant, then in step 560 a transaction is executed at the best price for the auctioned order. If there are multiple matches with multiple auction participants all submitting the same best price, then in step 565 the order is allocated among the auction participants that submitted the best price according to an allocation model. For example, customer orders on the book and incoming customer orders with the best price that are counterparts to the auctioned order are executed first, with specialists and market makers that submitted the same best price during the auction allocated the remainder of the auctioned order using an allocation ratio.

Other methods of the invention include variations on the method shown in FIG. 5 and can be described with reference to FIG. 5. In one method of the invention, the market query auction, a specialist or broker may have an order for auction, but rather than disclose the order to the crowd or to the auction module, the specialist or broker may simply initiate an auction specifying only the type of security that is the subject of the order, with the size of the order only being submitted at the initiator's option. Or a broker or specialist may wish to determine the best prices for a security even without an order for the security. Thus, in this method, in step 510 the specialist or broker submits the identity of the security in order to solicit the best available prices.

Like the order auction shown in FIG. 5, a market query auction may proceed as depicted in FIG. 4, with quotes and possibly improved price quotes being submitted by market makers 525, specialists 530, and floor brokers 540, and quotes may automatically be drawn from the order and quote book 520, as well as the best prices from competing exchanges. Floor brokers 540 may also submit orders into the auction, and liquidity from the order and quote book 520 may be automatically included in the auction. During the auction process, all parties can submit better prices and can update size quotes until the best prices are established or until some predetermined event causes the end of the auction.

After the auction closes and there is an indication of the best price, the auction initiator may elect to proceed no further and the process may be terminated 550 if the auction was initiated for informational purposes only, or if the best price was inadequate in the initiator's opinion to fill the order. Alternatively, if the auction initiator had an order to fill and the best price as determined through the auction is adequate, then the process proceeds as shown in FIG. 5 and as described above with the execution of a trade 555.

In another method of the invention, the market interest auction, a specialist or broker may have an order for auction for which no quote currently exists. For example, current quotes might specify bid and offer prices for 1000 shares of a security, but a broker may have an order for 3000 shares of the security. That broker thus may wish to submit the order for auction to determine a price for 3000 shares. Thus the market interest auction may proceed as shown in FIG. 5, beginning with the submission of the order for auction, specifying the order size.

The various systems and methods described above can be implemented on any computer by any person, limited only by the rules of the exchange or any applicable security laws and regulations. Furthermore, any or all of the steps described may be performed on either a single computer, or multiple computers, possibly networked together, and thus any computer means may be used to perform any or all of the steps.

The invention provides computer software for performing any or all of the processes and steps described herein. The computer software may be divided into component programs for performing the various operations described herein, operable together across networked computer systems. For example, the software may include a component program for executing trades, a separate program for routing orders, a separate auction module program, and a separate client module program, or any or all of these separate functions may be combined in any combination into a single program. The computer software of the invention may be stored on any data storage device, including but not limited to, hard drives, floppy disks, CD-ROMs, CD-RWs, DVDs, and solid state storage devices, such as smart media.

As should be apparent to those in the financial industry, the inventions are useful for trading or price discovery of any sort of financial instrument including stocks, bonds, ETFs, actively managed ETFs, options contracts, futures contracts, or any other derivative instruments.

While the embodiments described above provide illustrations and examples of the systems and methods of the invention, the invention should not be considered at all limited to these embodiments.

What is claimed is:

1. A system for improving the price of a commodity or financial instrument comprising: a first computer means running an auction module software program comprising instructions for causing the first computer means to:
receive an auction request from an auction initiator, wherein the auction request comprises data specifying the identity of the financial product,
transmit the auction request to a plurality of auction clients in the form of data specifying the identity of the financial product,
receive data comprising prices from the auction clients and orders and quotes from an electronic order and quote book,
compare the prices from the auction clients and quotes from the electronic orders and quotes book,
determine whether the auction should be terminated, and
select the best price; and
a second computer means running an auction client software program for causing the second computer means to:
receive the data specifying the identity of the financial product,
receive data input from an auction participant, wherein the input comprises the auction participant's best prices for the financial product, and
automatically transmit data comprising improved prices to the auction module,
wherein the auction initiator has the option of executing a transaction for the order at the best price.

2. The system of claim 1 wherein the auction request further comprises data specifying a quantity of the financial instrument and the side of the order.

3. The system of claim 2 wherein the side of the order is a buy order.

4. The system of claim 2 wherein the side of the order is a sell order.

5. The system of claim 2 wherein the side of the order is a short sell order.

6. The system of claim 1 wherein the auction module software program further comprises instructions for causing the first computer means to determine that there is an ongoing auction and to join the auction request with the ongoing auction.

7. The system of claim 1 wherein the auction module software program further comprises instructions for causing the first computer means to determine that there are multiple matches on both sides and to notify a specialist that there are multiple matches on both sides, wherein the specialist intervenes, sets a price, and executes the transactions.

8. A computer program product for improving the price of a commodity or financial instrument comprising:
auction module instructions for causing a first computer means to:
receive an auction request from an auction initiator, wherein the auction request comprises data specifying the identity of the financial product,
transmit the auction request to a plurality of auction clients in the form of data specifying the identity of the financial product,
receive data comprising prices from the auction clients and orders and quotes from an electronic order and quote book,
compare the prices from the auction clients and quotes from the electronic orders and quotes book,
determine whether the auction should be terminated, and
select the best price; and
auction client instructions for causing a second computer means to:
receive the data specifying the identity of the financial product,
receive data input from an auction participant, wherein the input comprises the auction participant's best prices for the financial product,
automatically transmit data comprising improved prices to the auction module,
wherein the auction module has the option of executing a transaction for the order at the best price.

9. The computer program product of claim 8 wherein the auction request further comprises data specifying a quantity of the financial instrument and the side of the order.

10. The computer program product of claim 9 wherein the side of the order is a buy order.

11. The computer program product of claim 9 wherein the side of the order is a sell order.

12. The computer program product of claim 9 wherein the side of the order is a short sell order.

13. The computer program product of claim 8 further comprising instructions for causing the first computer means to determine that there is an ongoing auction and to join the auction request with the ongoing auction.

14. The computer program product of claim 8 further comprising instructions for causing the first computer means to determine that there are multiple matches on both sides and to notify a specialist that there are multiple matches on both sides, wherein the specialist intervenes, sets a price, and executes the transactions.

15. A method for improving the price of a commodity or financial instrument comprising the steps:
receiving an auction request from an auction initiator at a first computer means programmed with auction module software, wherein the auction request comprises data specifying the identity of the financial product,
transmitting from the first computer means the auction request to a plurality of auction clients in the form of data specifying the identity of the financial product,
receiving at the first computer means data comprising prices from the auction clients and orders and quotes from an electronic order and quote book,
using the first computer means to compare the prices from the auction clients and quotes from the electronic orders and quotes book,
determining whether the auction should be terminated with the first computer means,
selecting the best price with the first computer means,
receiving the data specifying the identity of the financial product at a second computer means programmed with auction client software,
receiving data input from an auction participant at the second computer means, wherein the input comprises the auction participant's best prices for the financial product, and
automatically transmitting data comprising improved prices from the second computer means to the auction module,
wherein the auction initiator has the option of executing a transaction for the order at the best price.

16. The method of claim 15 wherein the auction request further comprises data specifying a quantity of the financial instrument and the side of the order.

17. The method of claim 16 wherein the side of the order is a buy order.

18. The method of claim 16 wherein the side of the order is a sell order.

19. The method of claim 16 wherein the side of the order is a short sell order.

20. The method of claim 15 further comprising the step of determining with the first computer means that there is an ongoing auction and joining the auction request with the ongoing auction.

21. The method of claim 15 further comprising the step of determining with the first computer means that there are multiple matches on both sides and notifying a specialist that there are multiple matches on both sides, wherein the specialist intervenes, sets a price, and executes the transactions.
